(19) United States
(12) Patent Application Publication
(10) Pub. No.: US 2005/0191028 A1
(43) Pub. Date: Sep. 1, 2005

(54) Moving-image playback device for mobile use

(75) Inventors: Masayuki Matsuda, Yokohama (JP); Tamotsu Ito, Ayase (JP); Yutaka Matsunobu, Hitachiota (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 10/892,274

(22) Filed: Jul. 16, 2004

(30) Foreign Application Priority Data
Mar. 1, 2004 (JP) 2004-056508

(51) Int. Cl. H04N 5/76; H04N 5/781

(52) U.S. Cl. 386/46; 386/125

(57) ABSTRACT

A moving-image playback terminal for mobile use includes a storage unit, a control unit, a video decoding unit, a text decoding unit, a display unit, and a power supply unit. The terminal plays back a stream in which encoded video information and text information are included. The moving-image playback terminal further includes a video decode on/off function that turns on/off an execution of video decoding in the video decoding unit. If the video decode on/off function is turned off when the stream is played back, the text decoding unit decodes text information but the video decoding unit does not decode video information.

### INCORPORATION BY REFERENCE

The present application claims priority from Japanese application JP2004-143830 filed on May 13, 2004, the content of which is hereby incorporated by reference into this application.

### TECHNICAL FIELD

The present invention relates to a moving-image playback device for mobile use, and more particularly to a moving-image playback device for mobile use with the power-saving function that saves power at moving-image playback time.

### BACKGROUND

Audio information and video information stored in a moving-image playback terminal is encoded to reduce the memory amount and is multiplexed to produce one stream of information. For some conventional flip-type moving-image playback terminals that can be folded, the backlight is turned off when the terminal is closed during the playback of a moving image and the video output to the liquid crystal unit is stopped to reduce the power consumption. At that time, the audio information is continuously decoded with the sound output from the speaker. For some terminals, the decoders provided for decoding encoded information, included in a stream containing encoded video information and audio information, are put in the standby state while the operation need not be performed in order to reduce the power consumption of the decoders. (For example, JP-A-2000-82261 (FIG. 1), JP-A-2001-159889, and JP-A-2002-27145).

A conventional moving-image playback terminal decodes video when there is video information but, when there is no video information, suppresses unnecessary standby power in order to reduce the power consumption of the whole decoder. Therefore, when there is video information, the terminal does not reduce the power consumption only by not decoding video information. In addition, the conventional terminal does not consider a case in which text information is included.

There is a need for an improved moving-image playback device for mobile use.

### SUMMARY

The above stated need is met by a moving-image playback device for mobile use that comprises a storage unit, a control unit, a video decode on/off function (means), a video decoding unit, a display unit, and a power supply unit. The moving-image playback terminal is characterized in that, when a stream in which encoded video information is included is played back, the video decode on/off function is turned off to prevent video information from being decoded. The activation condition for a function to change the video decode on/off function can be set in advance by the user of the moving-image playback terminal. The information that is prevented from being decoded in order to reduce power consumption includes not only video information but also audio information and text information.

That is, the moving-image playback device for mobile use comprises a storage unit, a control unit, a video decoding unit, a text decoding unit, a display unit, and a power supply unit, and plays back a stream in which encoded video information and text information are included. The moving-image playback device for mobile use further comprises a video decode on/off function that turns on or off an execution of video decoding in the video decoding unit wherein, if the control unit turns off the video decode on/off function when the stream is played back, the text decoding unit decodes text information but the video decoding unit does not decode video information.

When the video decode on/off function is turned off, the control unit limits a power supplied from the power supply unit to the video decoding unit.

The moving-image playback device also has an input unit. If a video decode suppression mode interrupt is generated from the input unit during a stream playback during which the video decoding unit decodes video information, the control unit turns off the video decode on/off function to prevent the video decoding unit from decoding the video information.

When the stream is played back with the video decode on/off function turned off to prevent the video decoding unit from decoding video information, the control unit turns on the video decode on/off function to cause the video decoding unit to decode the video information in response to an interrupt from the input unit.

The moving-image playback device sets an activation condition for a function, which changes the video decode on/off function, in advance in response to a user operation.

The control unit turns off the video decode on/off function when an electronic mail function is executed in response to a user operation.

The control unit turns off the video decode on/off function when the power supply unit detects a capacity low condition.

The control unit turns off the video decode on/off function in response to an interrupt generated when a flip-type body is closed.

The control unit turns off the video decode on/off function in response to an interrupt generated when a key assigned to a video decode suppression function is pressed.

If a frame to be decoded is not a frame that can be restored based only on encoded information on the frame when video decoding is restarted, a decoded video screen is not displayed, but a preset image or character string is displayed, on the display unit.

The above stated need is also met by a moving-image playback device for mobile use that comprises a storage unit, a control unit, a video decoding unit, an audio decoding unit, a text decoding unit, a display unit, and a power supply unit and that plays back a stream in which encoded video information, audio information, and text information are included. The device also has an audio decode on/off function that turns on or off an execution of audio decoding in the audio decoding unit. If the control unit turns off the audio decode on/off function when the stream is played back, the video decoding unit and the text decoding unit decode the video information and the text information but the audio decoding unit does not decode the audio information.

The above stated need is also met by a moving-image playback device for mobile use that comprises a storage unit, a control unit, a video decoding unit, an audio decoding unit, a text decoding unit, a display unit, and a power supply unit and that plays back a stream in which encoded video information, audio information, and text information are included. The device also has an on/off function for video decoding and so on that turns on or off an execution of video decoding and audio decoding in the video decoding unit and the audio decoding unit. If the control unit turns off the on/off function for video decoding and so on when the stream is played back, the text decoding unit decodes the text information but the video decoding unit and the audio decoding unit do not decode video information and the audio information.

The present invention provides a moving-image playback device for mobile use that can reduce power consumption and increase usability.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a moving-image playback terminal in a first-embodiment.

FIG. 2 is a block diagram showing a moving-image playback terminal in a second embodiment.

FIG. 3 is a schematic diagram showing the power consumption for decoding types FIG. 4 is a diagram showing an example of the process flow for each block in a third embodiment.

FIGS. 5A-5C are an example of displays on a display unit in a fourth embodiment.

FIG. 6 is a diagram showing an example of the process status for each block in a fifth embodiment.

FIG. 7 is a block diagram showing a moving-image playback terminal in a sixth embodiment.

### DESCRIPTION OF THE INVENTION

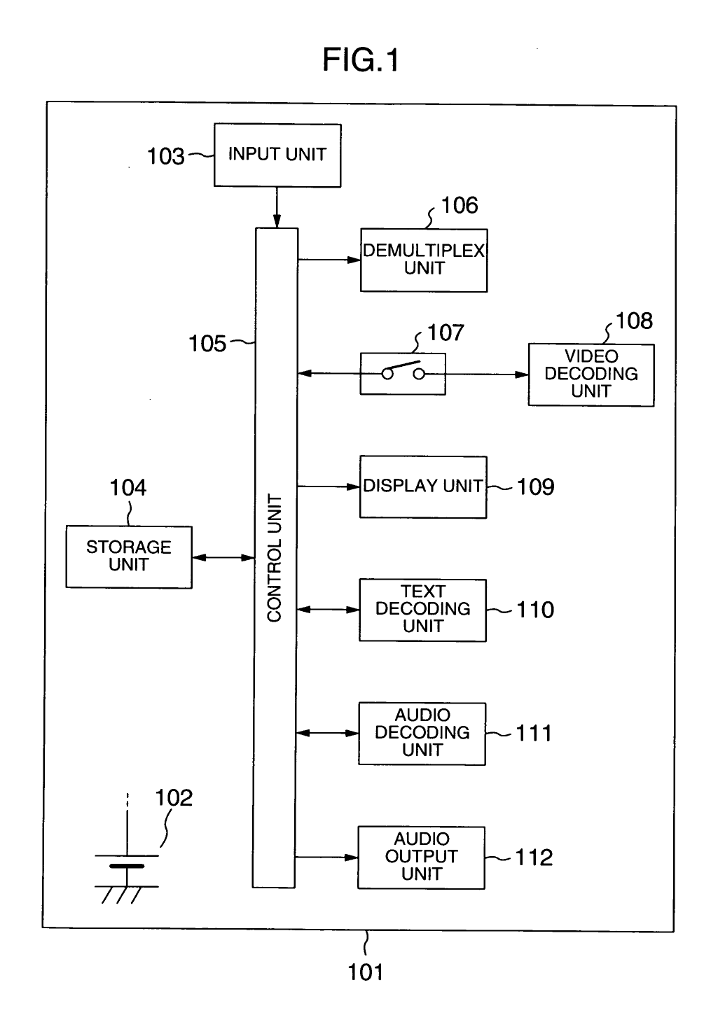

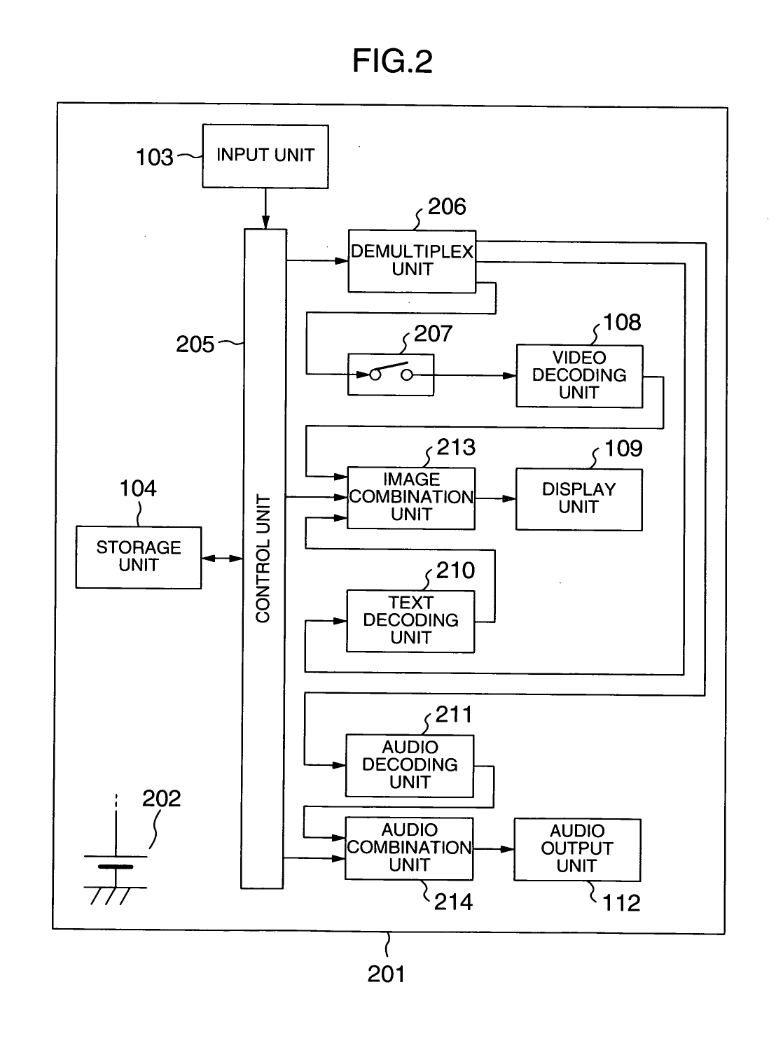

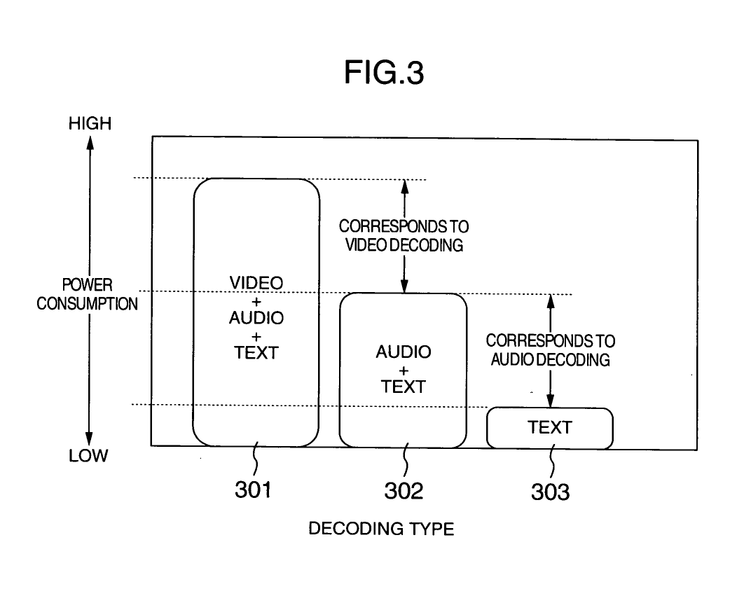

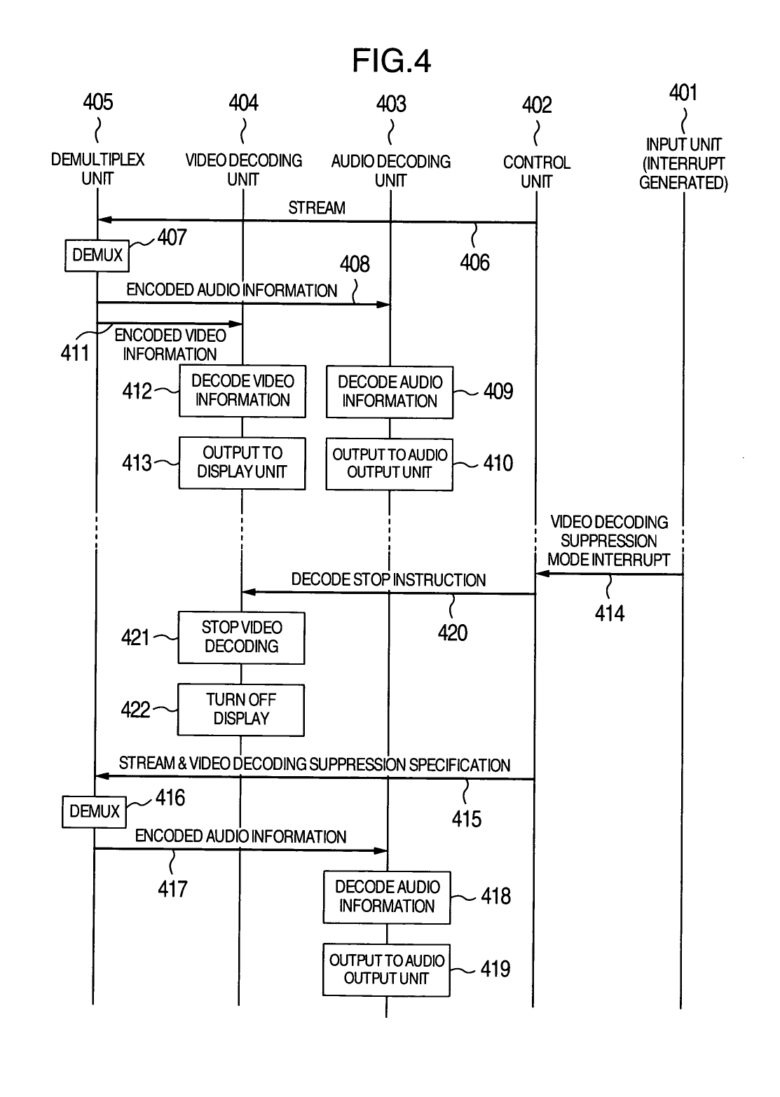

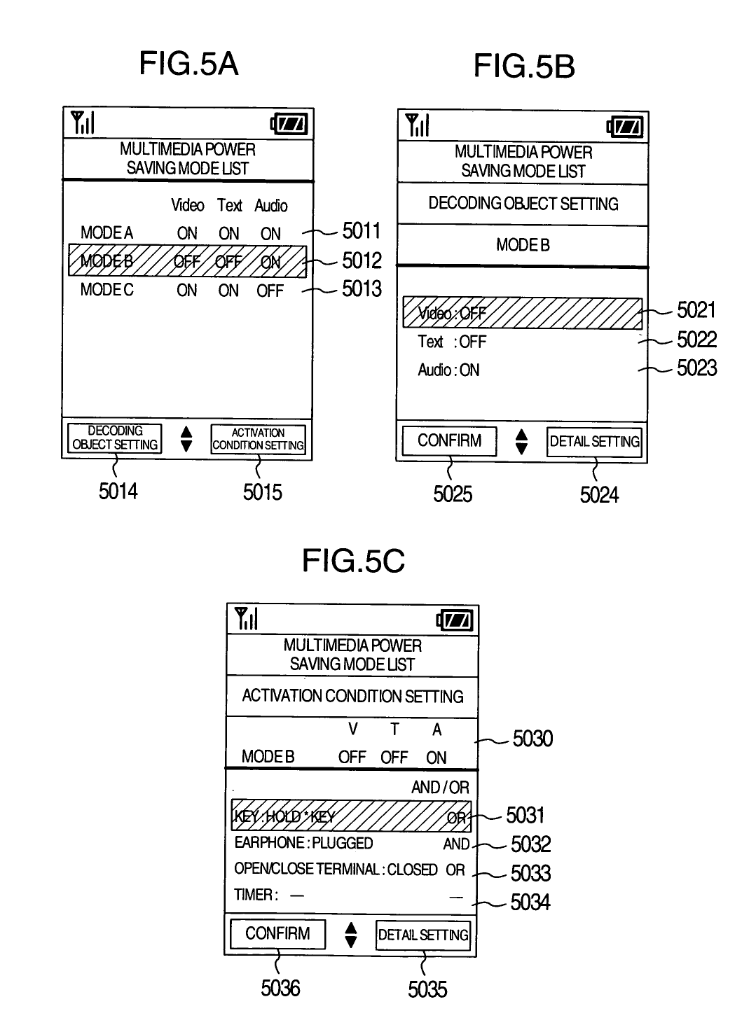

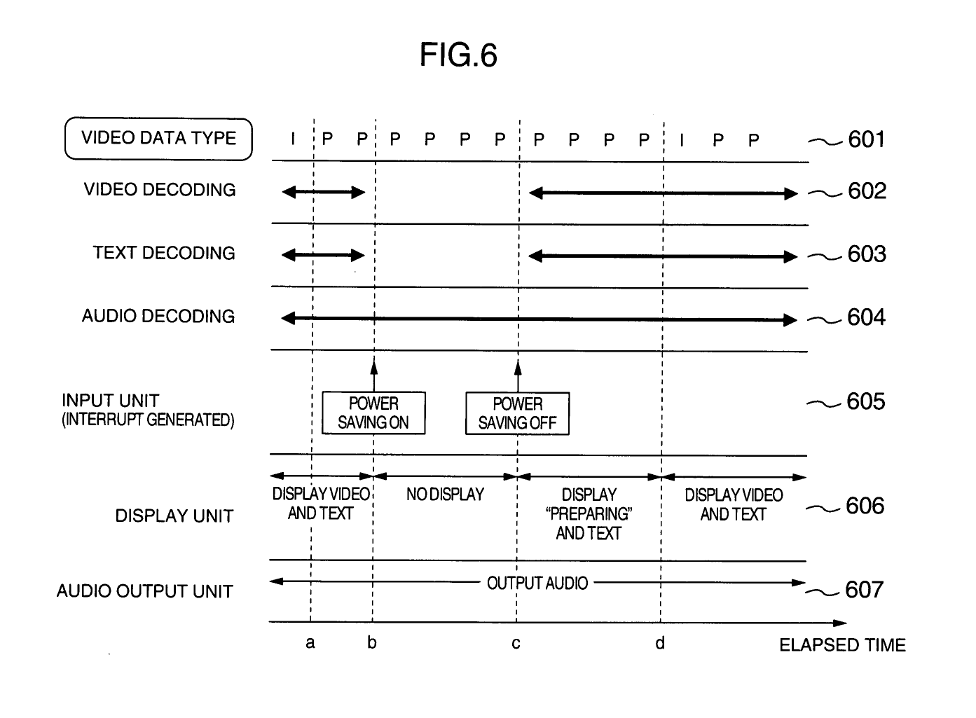

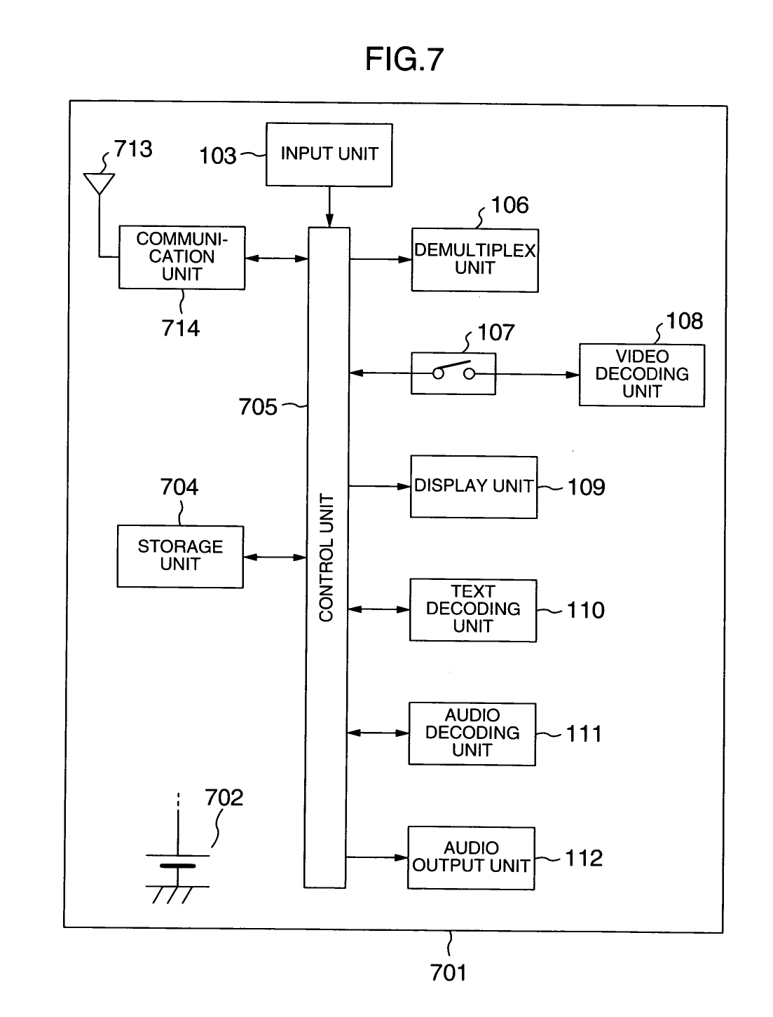

Some embodiments of a moving-image playback device for mobile use with the power saving function will be described below in detail with reference to the drawings. FIG. 1 is a block diagram showing a moving-image playback terminal in a first embodiment. FIG. 2 is a block diagram showing a moving-image playback terminal in a second embodiment. FIG. 3 is a schematic diagram showing the power consumption for each decoding type. FIG. 4 is a diagram showing an example of process flow for each block in a third embodiment. FIG. 5 is a diagram showing an example of display on a display unit in a fourth embodiment. FIG. 6 is a diagram showing an example of the process status of each block in a fifth embodiment. FIG. 7 is a block diagram showing a moving-image playback terminal in a sixth embodiment.

The first embodiment will be described. With reference of FIG. 1 to FIG. 3, the first embodiment will be described in which a moving-image playback terminal with the moving-image playback function in this embodiment reduces the power consumption, required for video decoding, by not decoding a video when an encoded stream to be played back includes video information.

FIG. 1 shows a moving-image playback terminal 101. The moving-image playback terminal 101 comprises a power supply unit 102 that supplies power to the blocks in the moving-image playback terminal 101; an input unit 103 that generates an interrupt for controlling the on/off control function of the present invention such as the opening and closing of the terminal including the keypad; a storage unit 104 in which a stream to be played back and a program code are stored; a control unit 105 that determines an interrupt from the input unit 103 and controls video decoding; a demultiplex unit 106 that demultiplexes a stream, in which encoded audio information, video information, and text information are multiplexed, into encoded audio information, encoded video information, and encoded text information; a decode on/off function 107 that switches the on/off function for decoding encoded video information; a video decoding unit 108 that decodes encoded video information obtained from the demultiplex unit 106; a display unit 109 that displays video information decoded by the video decoding unit 108 or a battery mark; a text decoding unit 110 that decodes encoded text information obtained from the demultiplex unit 106; an audio decoding unit 111 that decodes encoded audio information obtained from the demultiplex unit 106; and an audio output unit 112 composed of a speaker, headphones, or earphones from which audio information decoded by the audio decoding unit 111 is output. The power supply unit 102 comprises a battery.

First, the storage unit 104 contains a stream in which encoded audio information, video information, and text information are multiplexed. When a playback instruction is entered from the input unit 103 to the control unit 105 with a stream specified, the control unit 105 passes the specified stream to the demultiplex unit 106 and obtains encoded audio information, encoded video information, and encoded text information. The control unit 105 checks various inputs from the input unit 103 and turns on or off the decode on/off function 107. If the decode on/off function 107 is on, the encoded video information is passed to the video decoding unit 108 for decoding, is changed to a video screen that can be played back, and is passed back to the control unit 105. At this time, if the decode on/off function 107 is off, video is not decoded even if video information is included in the stream to be played back. This reduces the power consumption required for decoding the video.

Regardless of the status of the decode on/off function 107, the encoded text information is passed from the control unit 105 to the text decoding unit 110 for decoding and then passed back to the control unit 105. If the decode on/off function 107 is on at this time, the video data decoded by the video decoding unit and the decoded text information are combined in the control unit 105 and the combined information is displayed on the display unit 109 as one image. On the other hand, the decoded audio information is decoded by the audio decoding unit 111 and is passed back to the control unit 105. After that, the decoded audio information is passed from the control unit 105 to the audio output unit 112 for output.

How power consumption is saved by not decoding video information will be described with reference to the power consumption schematic diagram (FIG. 3) that indicates the power consumption for each decoding type. FIG. 3 is a schematic diagram showing the power consumption according to the decoding type. The vertical axis indicates the amount of power consumption, and the horizontal axis indicates the type of decoding. When a stream to be played back includes encoded audio information, video information, and text information that are multiplexed as described above and when the video information, audio information, and text information are decoded, the power consumption becomes high as shown by 301. In this case, if the video decode on/off function 107 in FIG. 1 is turned off, the decoding of the encoded video information is suppressed and therefore the power consumption required for video decoding is reduced. The power consumption indicated by 302 in FIG. 3 is lower than that indicated by 301.

Although whether or not video information is to be decoded is described above, it is also possible to suppress the decoding of not only video information but also audio information. In that case, because the decoding of both encoded video information and audio information is suppressed, video decoding processing and audio decoding processing are not performed and, as indicated by 303 in FIG. 3, the power consumption becomes still lower. Limiting the information to be decoded in this way makes it possible to further reduce the power consumption. For example, this can be used for viewing only text information of a video in a place where quietness is required such as transportation facilities, libraries, and restaurants.

As described above, if the video decode on/off function is turned off, the moving-image playback terminal with the moving-image playback function in this embodiment does not decode video information even if an encoded stream to be played back includes video information. This can reduce the power consumption, required for video decoding, by about 30%.

A second embodiment will be described. The block configuration described above can be changed as necessary. With reference to FIG. 1 and a block diagram (FIG. 2) that can be created by slightly changing the block configuration, the second embodiment will be described.

FIG. 2 shows a moving-image playback terminal 201. The moving-image playback terminal 201 comprises a power supply unit 202 that supplies power to the blocks in the moving-image playback terminal 201; a control unit 205 that determines an interrupt from the input unit and controls video decoding; a demultiplex unit 206 that demultiplexes a stream, in which encoded audio information, video information, and text information are multiplexed as one data unit, into encoded audio information, encoded video information, and encoded text information and passes the encoded information to the decoding units; a decode on/off function 207 that switches the on/off function for decoding encoded video information; a text decoding unit 210 that decodes encoded text information obtained from the demultiplex unit 206; an audio decoding unit 211 that decodes encoded audio information obtained from the demultiplex unit 206; an image combination unit 213 that combines video information decoded by the video decoding unit 108, control unit image information such as a battery mark obtained from the control unit 205, and text information decoded by the text decoding unit 210 and passes the combined information to the display unit 109 as an image; and an audio combination unit 214 that combines audio information decoded by the audio decoding unit 211 and control unit audio information, such as a key touch tone, obtained from the control unit 205 and passes the combined information to the audio output unit 112. The other blocks are the same as those in FIG. 1.

When the decode on/off function 207 is turned off, the configuration in FIG. 2 does not decode video information even if there is video information in a stream to be played back and therefore reduces the power consumption required for video decoding.

A third embodiment will be described. With reference to FIG. 2 and FIG. 4, the third embodiment will be described in which the video information decoding on/off function can be controlled during moving-image reproduction. FIG. 4 is a process flow diagram of the blocks showing the function of this embodiment. An input unit 401, a control unit 402, an audio decoding unit 403, a video decoding unit 404, and a demultiplex processing unit 405 indicate the input unit 103, the control unit 205, the audio decoding unit 211, the video decoding unit 108, and demultiplex unit 206 in FIG. 2, respectively.

First, the following describes a case in which decoding processing for encoded video information is not suppressed when a stream, which contains encoded audio information, video information, and text information that are multiplexed, is played back. The stream is passed from the control unit 402 to the demultiplex unit 405 (406) and is demultiplexed into encoded audio information and video information (process 407). Next, the encoded audio information is passed from the demultiplex unit 405 to the audio decoding unit 403 (408) for decoding audio information (process 409). The decoded audio information is passed to the audio output unit for output as audio data (process 410). Although not shown, text information is also demultiplexed and is decoded by the text decoding unit. The encoded video information obtained in process 407 is passed from the demultiplex unit 405 to the video decoding unit 404 (411) for decoding video information (process 412). The decoded video information is passed to the display unit and is output, in conjunction with the decoded text information, as image data (process 413).

To decode ordinary video information, the above flow is repeated to play back audio information, video information, and text information. When a video decode suppression mode interrupt occurs in this situation, the decode on/off function can be turned off during playback. Any type of interrupt can be used. An interrupt generated when a flip-type moving-image playback terminal is closed or an interrupt generated when a key assigned to the video-decode suppression function is pressed can be used. The decode on/off function may also be turned off when the user uses the electronic mail function (create or send mail or display mail, etc.) or when a low battery condition of the power supply unit is detected.

As a flip-type moving-image playback terminal, a folding cellular phone is known. To turn off video decoding and to turn on audio decoding when the terminal is closed and to turn on both video decoding and audio decoding when the terminal is opened, a mechanism for detecting whether the terminal is opened or closed is provided to generate an interrupt upon sensing that the terminal is opened or closed.

When the video decoding suppression mode interrupt described above is passed from the input unit 401 to the control unit 402 (414), the decoding stop instruction is passed first from the control unit 402 to the video decoding unit 404 (420) to cause the video decoding unit 404 to stop video decoding (process 421) and to suspend the display (process 422). Next, the corresponding data in the stream described above and the video decoding suppression specification are sent from the control unit 402 to the demultiplex unit 405 (415). Upon receiving the stream, the demultiplex unit 405 demultiplexes the stream to demultiplex it into encoded audio information, video information, and text information (process 416). Next, the encoded audio information is passed from the demultiplex unit 405 to the audio decoding unit 403 (417) to decode the audio information (process 418). The decoded audio information is passed to the audio output unit for output as audio data (process 419). The encoded text information is decoded. At this time, because the video decoding suppression specification was passed to the demultiplex unit 405 in process 415 described above, the information transfer from the demultiplex unit 405 to the video decoding unit 404 in the flow described above is suppressed to prevent video decoding processing from being performed. As a result, the decoding of the video information is suppressed and the power consumption required for video decoding can be reduced.

As described above, even when a moving image is being played back, an interrupt generated when the terminal is closed can turn off the video decoding processing function to prevent video information from being decoded, thus reducing the power consumption required for video decoding.

A fourth embodiment will be described. Although the decoding of video information is turned on or off in the first to third embodiments, it is also possible to turn on or off the decoding of audio information and text information. In addition, the decoding function can be turned on or off when the terminal is opened or closed or when a key assigned to the setting function is pressed. With reference to FIGS. 5A-5C, the following describes the fourth embodiment in which the user of the moving-image playback terminal can specify a decoding object for which the decoding function is to be turned on or off as well as an activation condition for turning on or off the function at the start of or during the playback of a moving image.

FIGS. 5A-5C show examples of screens displayed on the display unit when the function of the embodiment is executed. FIG. 5A shows a setting status list screen on which the setting status of the functions of this embodiment is displayed, FIG. 5B shows a decoding object setting screen, and FIG. 5C shows an activation condition setting screen for turning on/off the decoding function.

The setting status list screen (FIG. 5A) displays a list of setting status of the function of this embodiment with “Multimedia Power Saving Mode List” displayed at the top of the screen as the title. Although three power saving modes—mode A, mode B, and mode C—are shown as an example, the number of modes may be increased or decreased. Whether to decode video information, text information, and audio information is displayed for each mode. “ON, ON, ON” is set for mode A (5011), “OFF, OFF, ON” is set for mode B (5012), and “ON, ON, OFF” is set for mode C (5013). For example, mode A is a normal status in which power saving is not taken into consideration. In mode B, video information and text information are not decoded but only audio information is output when the moving-image playback terminal is closed. In mode C that is a manner mode setting prepared for use in a place such as a library where quietness is required, video information and text information are decoded but audio information is not decoded.

Those settings are all set to ON when the user purchases a terminal (initialized status). The screen may be changed from this screen to the decoding object setting screen (FIG. 5B) or to the activation condition setting screen for turning on/off the decoding function (FIG. 5C), which are assigned respectively to Soft Key Left not shown and to Soft Key Right not shown. For example, “Decoding object setting” 5014 is in the bottom left of the screen, and “Activation condition setting” 5015 is in the bottom right of the screen. The setting status list screen (FIG. 5A) shows an example in which mode B is selected by the cursor. The cursor can be moved with the up/down key not shown.

Pressing Soft Key Left (select 5014) on the setting status list screen (FIG. 5A) takes the user to the decoding object setting screen (FIG. 5B). FIG. 5B shows the decoding object setting screen on which “Multimedia power saving mode list Decoding object setting” is displayed at the top. This screen allows the user to set a decoding object in mode B. The current setting status is shown as displayed in 5012, that is, OFF for video, OFF for text, and ON for audio, from top to bottom. On this screen, the user can turn on or off the decoding of information. “Detail setting” 5024 is assigned to Soft Key Right, not displayed, to allow the user to display the detailed setting screen to turn on or off the detail. “Confirm” 5025 is assigned to Soft Key Left, not displayed, to allow the user to confirm the setting specified for the detail setting.

On the decoding object setting screen (FIG. 5B), the cursor 5021 is on the setting for turning on or off the decoding of video information. In this case, pressing Soft Key Right (select 5024) allows the user to specify the detail setting indicating whether to decode encoded video information when video information is included in the stream. The cursor can be moved up or down by pressing the up/down key on the decoding object setting screen (FIG. 5B) and, therefore, can be moved to the setting 5022 for turning on or off the decoding of text information or to the setting 5023 for turning on or off the decoding of audio information.

After specifying the on/off setting for the decoding of information, the user can press the Soft Key Left (select 5025) to “confirm” the setting status and return to the setting status list screen (FIG. 5A).

Pressing Soft Key Right (select 5015) on the setting status list screen (FIG. 5A) takes the user to the activation condition setting screen for turning on/off the decoding function (FIG. 5C). On the screen shown in FIG. 5C for specifying a decoding on/off function activation condition, “Multimedia power saving mode list Activation condition setting” is displayed at the top. In this screen example, the decoding object setting in mode B is displayed in an area 5030 so that the user can understand the setting mode easily. In the display example, an activation condition for mode B can be set.

The activation condition setting includes a the setting of key assigned to the decoding suppression function 5031, whether or not earphones are plugged 5032, a terminal open/close setting for a flip-type moving-image playback terminal 5033, and a timer setting that is the elapsed time from the start of the playback of a moving image stream. In addition, a setting requiring that all conditions must be satisfied or a setting indicating that any combination may be satisfied can be represented by “OR” and “AND”. For example, on the activation condition setting screen (FIG. 5C) for turning on or off the decoding function, “Hold * key” and “OR” are specified for Key, “Plugged” and “AND” are specified for Earphone, “Closed” and “OR” are specified for Open/close terminal, and no setting is specified for Timer. Therefore, this setting indicates that the earphones must be plugged and, in that status, the mode moves to mode B only when the * key is held or the terminal is closed. In mode B, video information and text information are not decoded but only audio information is decoded.

On this screen, the key setting for various types of information or the detail setting, for example, the terminal open/close status, can be specified. “Detail setting” 5035 is assigned to Soft Key Right, not displayed, to allow the user to move to the detail setting screen where the user can specify various settings or select AND/OR. “Confirm” 5036, which is assigned to Soft Key Left not displayed, is used to confirm the settings specified during detail setting.

The detail key setting 5031 is selected on the activation condition setting screen for turning on/off the decoding function (FIG. 5C). When Soft Key Right is pressed (select 5035), the key to be assigned to the decoding suppression function can be set or AND/OR can be selected. The user can move up and down the cursor by pressing the up/down key on the activation condition specification screen for turning on/off the decoding function (FIG. 5C) and, by placing the cursor on an activation condition setting, can set its detail. After setting the activation conditions, the user presses Soft Key Left (select 5036) to “confirm” the setting and return to the setting status list screen (FIG. 5A).

As described above, the user of the moving-image playback terminal can easily specify an object that is decoded under control of the decode on/off function as well as an activation conditions for turning on/off the decoding of the object. This makes it possible to manage power consumption in a variety of ways.

A fifth embodiment will be described. With reference to FIG. 6, the fifth embodiment will be described in which, if a picture to be decoded is not a picture that can be decoded based only on the coded information of the picture, the video screen that will be created after decoding is not displayed, but a pre-set character string is displayed, on the display unit.

FIG. 6 shows the processing status of the blocks. The horizontal axis indicates the elapsed time. The veridical axis indicates, from top to bottom, the video data type (601) indicating the type of picture to be decoded, whether or not video decoding processing is required for the video data type (602), whether or not text decoding processing is required (603), whether or not audio decoding processing is required (604), the status of the generation of an interrupt from the input unit (605), the output on the display unit (606), and the output to the audio output unit (607).

First, assume that a stream to be played back contains encoded audio information, video information, and text information that are multiplexed. Also assume that the video information is encoded according to the MPEG (Moving Picture Experts Group: the name of standard for moving pictures) standard. The type of the video data before time a is an I picture (Intra-Picture: a screen compressed as a still image. It can be encoded using only the information in that screen without using correlative information on other screens that precede and follow in time) that can be decoded based only on the encoded information on the picture. The video information, text information, and audio information are decoded, the video information and text information are displayed on the display unit, and the audio information is output from the audio output unit. From time a to time b, the type of video data is a P picture that is a predictively encoded picture (Predictive-Picture: a screen represented by correlative information from the past screens in time. A screen to be referenced may contain either an I picture or a P picture. The amount of a P picture is smaller than that of an I picture). As when the video data type is an I picture, video information, text information, and audio information are decoded, the video information is displayed on the display unit, and audio information is output from the audio output unit.

Next, when a power saving ON interrupt is generated from the input unit at time b, for example, in mode B in FIGS. 5A-5C, the mode is switched to the video and text decoding suppression mode and the video and text information is not decoded. The audio information is decoded continuously as before time a. No information is displayed on the display unit, and no audio information is output from the audio output unit.

Next, at time c, when an interrupt is generated from the input unit or a power saving OFF interrupt is generated or a power saving ON interrupt in mode A in FIGS. 5A-5C is generated, the mode returns to a mode in which all the video information, text information, and audio information are decoded. Because the video data type is a P picture, the screen to be displayed cannot be restored completely even if the video information is decoded and, therefore, a preset character string such as “Preparing” and the decoded text information are displayed. In this case, the decoded screen, which is not restored completely, may also be displayed. Alternatively, it is also possible not to decode the video information until the video data type becomes an I picture. In addition, it is also possible not to decode the video information and text information until the video can be completely restored. The audio information is continuously decoded even after time c, and the audio information is output from the audio output unit. Next, because the video data type becomes an I picture at time d, the screen to be displayed can be restored completely when the video information is decoded. Therefore, both the video information and the text information are displayed on the display unit.

Although the character string “Preparing” is displayed in this embodiment, a preset image may also be displayed.

As described above, if a picture to be decoded is not a picture that can be restored by decoding based only on the encoded information on that picture depending upon the processing status of the blocks, a preset image or character string can be displayed on the display unit instead of the decoded video screen. In this way, a moving-image playback terminal that does not display an unnatural image but that continuously decodes the audio information and continuously outputs the sound is provided.

A sixth embodiment will be described. With reference to FIG. 1 and FIG. 7, the sixth embodiment will be described in which a stream containing encoded video information is received not from the internal memory of the moving-image playback terminal but from an external source of the moving-image playback terminal. FIG. 7 shows a moving-image playback terminal 701 that implements the function of the present invention. This block diagram is created by slightly changing the block configuration shown in FIG. 1. The moving-image playback terminal 701 comprises a power supply unit 702 that supplies power to the blocks in the moving-image playback terminal 701; a storage unit 704 in which program code and so on are stored; a control unit 705 that determines an interrupt from the input unit, controls video decoding, and performs base-band processing such as the internal processing of information received from an external source of the moving-image playback terminal; an antenna 713 that receives a stream, which includes the encoded video information, from an external source of the moving-image playback terminal for use in the moving-image playback terminal 701; and a communication unit 714 that passes the stream, which includes the encoded video information received from the antenna 713, to the control unit 705. The other blocks are the same as those shown in FIG. 1.

For example, the information source may be a terrestrial digital broadcasting, a communication provided by a streaming service, or a communication provided by a live camera service. First, a base station not shown sends a stream in which encoded audio information, video information, and text information are multiplexed. This stream is sent to the moving-image playback terminal 701 via the antenna 713 and is passed to the communication unit 714. The communication unit 714 converts the received stream into data usable in the moving-image playback terminal 701 and passes the converted stream to the control unit 705.

In response to an input request from the input unit 103 requesting the control unit 705 to play back a stream, the control unit 705 passes the stream to the demultiplex unit 106 that demultiplexes the stream into encoded audio information, encoded video information, and encoded text information. The control unit 705 checks various inputs from the input unit 103 and turns on or off the decode on/off function 107. If the decode on/off function 107 is turned on, the encoded video information is passed to the video decoding unit 108 for decoding into a video screen that can be played back and the video screen is then passed back to the control unit 705. If the decode on/off function 107 is turned off, the video information is not decoded even if the stream to be played back includes video information. Thus, the power consumption required for decoding the video can be reduced.

Regardless of whether the decode on/off function 107 is turned on or off, the encoded text information is passed from the control unit 705 to the text decoding unit 110 for decoding and then passed back to the control unit 705. If the decode on/off function 107 is turned on, the video data decoded by the video decoding unit 108 and the decoded text information are combined by the control unit 705 and the combined information is displayed on the display unit 109 as one image. On the other hand, the encoded audio information is decoded by the audio decoding unit 111 and is passed back to the control unit 705. After that, the decoded audio information is passed from the control unit 705 to the audio output unit 112 for output.

As described above, if the decode on/off function is turned off, the moving-image playback terminal according to the present invention, which has a unit for receiving radio waves provided by the terrestrial digital service, does not decode video information even if an encoded stream to be played back includes video information. In this way, the power consumption required for decoding video information can be reduced.

For the service for downloading a stream from a base station, it is also possible to store a part or the whole of the stream in the storage unit without decoding it even if the decode on/off function is turned off when the stream is received from the base station. In that case, the stream is played back in response to an interrupt from the input unit. The present invention provides the function to store a stream in the moving-image playback terminal. The stream may be stored not only in the storage unit in the moving-image playback terminal but also in an external memory.

In the description of the above embodiments, the power consumption required for decoding video information can be reduced by not decoding video information. It is also possible to further reduce the power consumption by limiting the power, supplied from the power supply unit to the video decoding unit, under control of the control unit. Although the decoding of video information is turned on or off to save power, the decoding of audio information or text information may also be turned on or off to save power.

In the first to sixth embodiments, the text decoding unit decodes text information but the video decoding unit does not decode video information. It is also possible that the video decoding unit decodes video information but that the audio decoding unit does not decode audio information. This reduces the power consumption and, at the same time, allows the user to view only video information even in a place where quietness is required.

In the description of the above embodiments, a moving-image playback device with the moving-image playback function is provided. The device is a mobile-use, moving-image playback device with the power saving function that reduces power consumption required for decoding video information by not decoding video information included in an encoded stream to be played back. In addition, the device is a mobile-use, moving-image playback device with the power saving function that can turn off the decoding of video information even during the playback of a moving image in response to an interrupt generated when the device is closed and thereby can reduce the power consumption required for decoding the video information.

That is, the moving-image playback device is advantageously used when the user does not view a video but listen to an audio. For example, the user, who views a TV program in a train with the earphones inserted, once closes the mobile phone when the user transfers the train. In this case, the user can stop decoding only the video information but can keep on decoding the audio information in order to continuously listen to the audio of the TV program while walking on the platform. The moving-image playback device is advantageously used also when the user receives a mail while viewing a TV program. In this case, the user can stop decoding only the video information but can keep on decoding the audio information while confirming the mail. This allows the user to continuously listen to the audio while reading a mail or to continuously listen to the audio while creating a return mail. This is useful also when the user browses a web page. In addition, when the battery becomes low and a warning is issued to alert that the viewing time will run out soon, the user can stop decoding only the video information but can keep on decoding only the audio information to listen to the audio of the TV program. This is especially useful for a broadcast program, such as a sports broadcast or a news program, that can be understood only via the audio.

The user of a moving-image playback terminal may easily specify a decoding object by turning on or off the decoding function or to easily specify an activation condition for controlling the decode on/off function, thus providing a moving-image playback device with the power saving function that allows the user to manage the power consumption in a variety of ways.

It should be further understood by those skilled in the art that although the foregoing description has been made on embodiments of the invention, the invention is not limited thereto and various changes and modifications may be made without departing from the spirit of the invention and the scope of the appended claims.

1. A moving-image playback device for mobile use that comprises a storage unit, a control unit, a video decoding unit, a text decoding unit, a display unit, and a power supply unit and that plays back a stream in which encoded video information and text information are included,
further comprising a video decode on/off function that turns on or off an execution of video decoding in said video decoding unit,
wherein, if said control unit turns off said video decode on/off function when the stream is played back, said text decoding unit decodes text information but said video decoding unit does not decode video information.

2. The moving-image playback device for mobile use according to claim 1,
wherein, when said video decode on/off function is turned off, said control unit limits a power supplied from said power supply unit to the video decoding unit.

3. The moving-image playback device for mobile use according to claim 1,
further comprising an input unit,
wherein, if a video decode suppression mode interrupt is generated from said input unit when said video decoding unit decodes video information, said control unit turns off said video decode on/off function to prevent said video decoding unit from decoding the video information.

4. The moving-image playback device for mobile use according to claim 1,
further comprising an input unit,
wherein, if the stream is played back when said video decode on/off function is turned off to prevent said video decoding unit from decoding video information, said control unit turns on said video decode on/off function to cause said video decoding unit to decode the video information in response to an interrupt from said input unit.

5. The moving-image playback device for mobile use according to claim 1,
wherein an activation condition for a function, which changes said video decode on/off function, is set in advance in response to a user operation.

6. The moving-image playback device for mobile use according to claim 1,
wherein said control unit turns off the video decode on/off function when an electronic mail function is executed in response to a user operation.

7. The moving-image playback device for mobile use according to claim 1,
wherein said control unit turns off the video decode on/off function when said power supply unit detects a capacity low condition.

8. The moving-image playback device for mobile use according to claim 1,
wherein said control unit turns off the video decode on/off function in response to an interrupt generated when a flip-type body is closed.

9. The moving-image playback device for mobile use according to claim 1,
wherein an interrupt is generated and said control unit turns off the video decode on/off function in response to the interrupt when a key assigned to a video decode suppression function is pressed.

10. The moving-image playback device for mobile use according to claim 1,
wherein, if a frame to be decoded is not a frame that can be restored based only on encoded information on the frame when video decoding is restarted, a decoded video screen is not displayed, but a preset image or character string is displayed, on said display unit.

11. A moving-image playback device for mobile use that comprises a storage unit, a control unit, a video decoding unit, an audio decoding unit, a display unit, and a power supply unit and that plays back a stream in which encoded video information and audio information are included,
further comprising a video decode on/off function that turns on or off an execution of video decoding in said video decoding unit,
wherein, if said control unit turns off said video decode on/off function when the stream is played back, said audio decoding unit decodes the audio information but said video decoding unit does not decode the video information.

12. A moving-image playback device for mobile use that comprises a storage unit, a control unit, a video decoding unit, an audio decoding unit, a text decoding unit, a display unit, and a power supply unit and that plays back a stream in which encoded video information, audio information, and text information are included,
further comprising an audio decode on/off function that turns on or off an execution of audio decoding in said audio decoding unit,
wherein, if said control unit turns off said audio decode on/off function when the stream is played back, said video decoding unit and said text decoding unit decode the video information and the text information but said audio decoding unit does not decode the audio information.
